(19) United States
(12) Patent Application Publication
(10) Pub. No.: US 2014/0208349 A1
(43) Pub. Date: Jul. 24, 2014

(54) METHOD AND SYSTEM FOR UNINTERRUPTED BROADCAST CONTENT PROVISIONING

(71) Applicants: Rajith Raman Pillai Indusekharan Nair, Trivandrum (IN); Ajin Alias Mammoottil, Trivandrum (IN); Sreeraj Sreekumar Menon, Ernakulam (IN)

(72) Inventors: Rajith Raman Pillai Indusekharan Nair, Trivandrum (IN); Ajin Alias Mammoottil, Trivandrum (IN); Sreeraj Sreekumar Menon, Ernakulam (IN)

(73) Assignee: Wipro Limited, Bangalore (IN)

(21) Appl. No.: 13/853,521

(22) Filed: Mar. 29, 2013

(30) Foreign Application Priority Data
Jan. 21, 2013 (IN) 276/CHE/2013

(51) Int. Cl. H04N 21/24; H04N 21/61

(52) U.S. Cl. CPC H04N 21/2402; H04N 21/6125
USPC 725/34

(57) ABSTRACT

A method and system for uninterrupted broadcast content provisioning is disclosed. The method and system includes receiving one or more transport streams corresponding to one or more broadcast programs. The one or more transport streams may be transmitted using one or more of a satellite medium, a cable medium, and a terrestrial medium. One or more of the one or more received broadcast programs are then monitored using one or more hardware processor to detect an interruption in reception of the one or more of the one or more broadcast programs. On detecting an interruption, the one or more of the one or more broadcast programs are rendered automatically from one or more standby sources from the point of interruption of the one or more of the one or more broadcast programs.

### PRIORITY CLAIM

This disclosure claims priority under 35 U.S.C. §119 to: India Application No. 276/CHE/2013, filed Jan. 21, 2013, and entitled “METHOD AND SYSTEM FOR UNINTERRUPTED BROADCAST CONTENT PROVISIONING.” The aforementioned application is incorporated herein by reference in its entirety.

### TECHNICAL FIELD

The disclosure generally relates to broadcast content transmitted through one or more broadcast medium and more specifically relates to a method and system for providing uninterrupted broadcast content when there is a loss of broadcast signal.

### BACKGROUND

Broadcast television and radio programs have become an integral part of our daily lives. Over the years, many different mechanisms have been devised to provide consumers with broadcast content. Some commonly known broadcast mechanisms include terrestrial broadcast systems, cable broadcast systems, and satellite broadcast systems. Achieving greater range of transmission of broadcast content has been one of the driving factors in developing broadcast systems. In this regard, cable broadcast systems were developed to provide a greater range of transmission than terrestrial broadcast systems and satellite broadcast systems were developed to further increase the range of transmission than that provided by cable broadcast systems.

Although each of terrestrial broadcast systems, cable broadcast systems, and satellite broadcast systems have their advantages, a common drawback across all broadcast systems is loss of broadcast signal due to various reasons. For example, adverse weather conditions such as rain or snow lead to loss of signal in satellite broadcast systems. Similarly, since cable broadcast systems involve routing cables through cities and through wooded area, accidental snapping of cables that deliver broadcast signals is quite common.

In case of television broadcasts, if a pre-recorded broadcast program or a live broadcast program is interrupted in the middle due to signal loss, the viewer sees a blank or raster screen on the displaying device until the signal is reestablished. Such interruptions, especially during the critical portions or the climax of the program may frustrate and annoy the viewer. At times it may so happen that the program may have already ended when the signal gets reestablished. If the viewer searches for alternate options like online streaming of the program, if available, the viewer needs to go to the service provider's URL manually to initiate the program view from the beginning. Such a manual process affects the mood of the viewer who might have already watched some part of the broadcast program and is forced to watch the program again from the beginning

### SUMMARY

In accordance with some embodiments of the invention, an uninterrupted broadcast content provisioning method is disclosed. The method includes receiving one or more transport streams corresponding to one or more broadcast programs. The one or more transport streams may be transmitted using one or more of a satellite medium, a cable medium, and a terrestrial medium. One or more of the one or more received broadcast programs are monitored using one or more hardware processors to detect an interruption in reception of the one or more of the one or more received broadcast programs. On detecting an interruption in the reception of the one or more of the one or more broadcast programs, the one or more of the one or more broadcast programs are provided automatically from one or more standby sources from the point of interruption of the one or more of the one or more broadcast programs.

In accordance with some embodiments of the invention, an uninterrupted broadcast content provisioning system is disclosed. The system includes a broadcast receiver configured to receive one or more transport streams corresponding to one or more broadcast programs. The one or more transport streams may be transmitted using one or more of a satellite medium, a cable medium, and a terrestrial medium. The system also includes a monitoring module configured to monitor one or more of the one or more broadcast programs to detect an interruption in reception of the one or more of the one or more broadcast programs. When the monitoring module detects an interruption in reception of the one or more of the one or more broadcast programs, one or more standby sources automatically provide the one or more of the one or more broadcast programs. The one or more of the one or more broadcast programs is provided from a point of interruption of the one or more of the one or more broadcast programs.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the invention.

FIG. 1 illustrates an exemplary broadcast environment in which various embodiments of the invention function.

FIG. 2 illustrates a flowchart for a method of uninterrupted broadcast content provisioning in accordance with some embodiments of the invention.

FIG. 3 illustrates a block diagram of a system for uninterrupted broadcast content provisioning in accordance with some embodiments of the invention.

### DETAILED DESCRIPTION

Now, exemplary embodiments will be described with reference to the accompanying drawings. Wherever possible, the same reference numbers will be used throughout the drawings to refer to the same or like parts. While exemplary embodiments and features of the invention are described herein, modifications, adaptations, and other implementations are possible, without departing from the spirit and scope of the invention. Accordingly, the following detailed description does not limit the invention. Instead, the proper scope of the invention is defined by the appended claims.

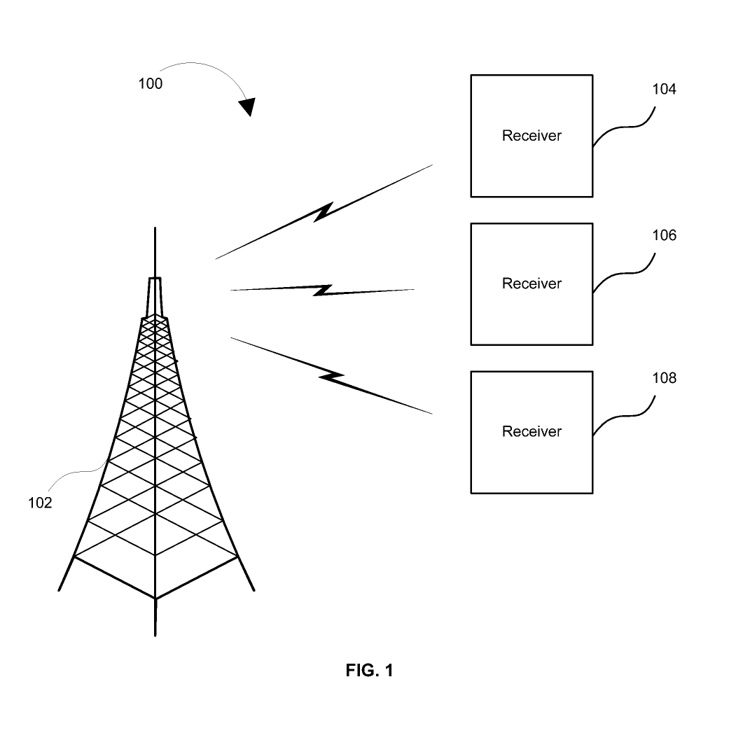

FIG. 1 illustrates an exemplary broadcast environment 100 in which various embodiments of the disclosure may function. Broadcast environment 100 may include a broadcast station 102 that transmits broadcast signals to one or more receivers, such as a receiver 104, a receiver 106, and a receiver 108. Here, each of receiver 104, receiver 106, and receiver 108 may be associated with, but not limited to, a television and a set top box. Although FIG. 1 illustrates three receivers, receiver 104, receiver 106, and receiver 108, it will be apparent to a person skilled in the art that any number of receivers may be employed to receive the broadcast signals without deviating from the scope of the invention.

Broadcast environment 100 is a generic representation of a broadcast system and may be configured to include, but not be limited to, a terrestrial broadcast system; a cable broadcast system, and a satellite broadcast system. In a terrestrial broadcast configuration, broadcast station 102 may transmit broadcast signals associated with broadcast content over the air into a surrounding area. These broadcast signals may be received by one or more of receiver 104, receiver 106, and receiver 108. Each of receiver 104, receiver 106, and receiver 108 may include an antenna (not shown in FIG. 1) for receiving the broadcast signals. On receiving the broadcast signals, the broadcast signals may be processed to display the broadcast content.

In some embodiments, broadcast environment 100 may also be configured to support a cable broadcast system. In this configuration, the broadcast signals transmitted by broadcast station 102 may be received by one or more common antennas (not shown in FIG. 1) as opposed to an antenna associated with each of receiver 104, receiver 106, and receiver 108. The broadcast signals may then be distributed from the common antenna to receiver 104, receiver 106, and receiver 108 via cables (e.g., fiber-optic, coaxial, etc.).

In some embodiments, broadcast environment 100 may include one or more satellites orbiting the Earth (not shown in FIG. 1). In such embodiments, broadcast station 102 may transmit the broadcast signals to the one or more orbiting satellites. The one or more satellites may then re-transmit the broadcast signals back to the Earth. These re-transmitted broadcast signals may be picked up by a parabolic antenna associated with each of receiver 104, receiver 106, and receiver 108. Receivers 104-108 may then process the broadcast signals to obtain the broadcast content.

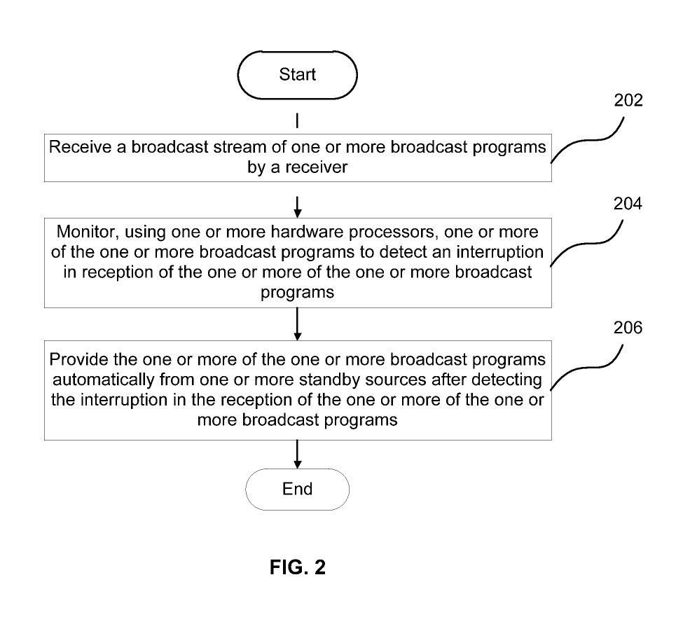

An uninterrupted broadcast provisioning method in accordance with some embodiments will now be described in conjunction with FIG. 2. The method includes receiving one or more transport streams corresponding to one or more broadcast programs by a receiver at step 202. A broadcast program of the one or more broadcast programs (hereinafter referred as “received broadcast programs”) may be a television broadcast program. A transport stream may be a multiplexed stream that includes video packets, audio packets, and/or data packets, which may contain program specific information and other associated information. Each transport stream may be transmitted at a particular frequency by a broadcasting station, and may include one or more channels or services, which in turn may include one or more broadcast programs. The broadcasting station may transmit the one or more transport streams using one or more broadcast media including, but not limited to, a terrestrial broadcast medium, a cable broadcast medium, and/or a satellite broadcast medium.

At step 204, one or more of the received broadcast programs may be monitored to detect an interruption in reception of the one or more received broadcast programs. One or more hardware processors may be used to monitor the one or more received broadcast programs to detect an interruption. On detecting an interruption in the reception of the one or more received broadcast programs, the one or more received broadcast programs may be automatically provided from one or more standby sources at step 206.

In some embodiments, all the received broadcast programs may be monitored for interruptions and subsequently provided by the one or more standby sources in case of an interruption or loss of signal. Alternatively, one or more received broadcast programs may be selectively monitored for interruptions. In some embodiments, the one or more received broadcast programs to be monitored may be automatically chosen based on a profile of a consumer. For example, in some embodiments, the profile of the consumer may be created during setup of the receiver and may be automatically updated periodically. The profile of the consumer may include, but not be limited to, channels subscribed by the consumer, viewing patterns of the consumer, preferred genres of broadcast programs, and preferred broadcast programs. For example, the receiver may determine that the consumer tunes in to a particular channel at the same time every day. The receiver may then predict that the broadcast program being received on that channel at that time is important to the consumer and may automatically monitor that broadcast program for interruptions. If an interruption occurs, the broadcast program may be automatically provided from the one or more standby sources such that the consumer does not miss out on the important broadcast program in case of a signal loss. In some embodiments, genres of broadcast programs preferred by a consumer may be determined by tracking viewing patterns of the consumer. In another example, the consumer may create the profile by providing a one-time input specifying one or more preferred broadcast programs or genres of broadcast programs during setup of the receiver. These preferred broadcast programs or broadcast programs belonging to the preferred genres of broadcast programs may then automatically chosen in future to be monitored for interruptions. Prediction data (e.g., including, without limitation: consumer profile ID, channel ID, broadcast start time, broadcast end time, probability of consumer tuning in, confidence level of tuning-in prediction, probability of interruption, confidence level of interruption prediction, genre ID, genre preference level, confidence level of genre preference prediction, and/or the like) may be stored in a database (e.g., locally in the receiver, locally in the display system, and/or remotely at a server), which the receiver may access before making a determination of whether to monitor that broadcast program for interruptions.

In some embodiments, the consumer may dynamically choose one or more received broadcast programs to be monitored. In this case, the one or more received broadcast programs may be monitored only when dynamically chosen by the consumer. It will be apparent to a person skilled in the art that various combinations of automatically choosing and manually choosing broadcast programs to be monitored are possible without deviating from the scope of the invention.

The one or more received broadcast programs which are chosen to be monitored for interruptions may belong to a single transport stream or may belong to two or more transport streams. Further, two or more broadcast programs which share the same or overlapping timeslots may be chosen to be monitored for interruptions. For example, a consumer may choose two broadcast programs belonging to two different transport streams and being transmitted in overlapping timeslots to be monitored for interruptions. In this case, if an interruption occurs, both the broadcast programs are provided from the one or more standby sources. Thus, any combination of the received broadcast programs may be chosen to be provided by the one or more standby sources in case of an interruption or loss of signal.

In some embodiments, a standby source of the one or more standby sources may be a local storage device associated with the receiver. In this case, one or more of the one or more received broadcast programs chosen to be monitored are prefetched into the local storage device before the actual broadcast of the program over the one or more broadcast medium. If a broadcast program is chosen to be monitored and provided from the local storage device in case of an interruption, identifying information associated with the broadcast program may be transmitted to a broadcaster of the broadcast program. The broadcaster may then schedule to transmit the broadcast program at a predefined time before the actual transmission of the broadcast program. The broadcaster may transmit the broadcast program using one or more of the terrestrial medium, the cable medium, and the satellite medium. In some embodiments, the broadcaster may transmit the broadcast program more than once, e.g., at periodic intervals or on-demand. The broadcaster may provide the receiver the times at which the broadcaster would transmit the one or more monitored broadcast programs so that the receiver can prefetch the one or more monitored programs during these times (in the case of on-demand broadcasting, the receiver may begin pre-fetching immediately upon notification of imminent transmission of the on-demand monitored broadcast program). The receiver may further prepare to prefetch the broadcast program into the local storage device based on these times. For example, the receiver may delete unwanted data from the local storage device in order to provide sufficient storage space before the predefined time so that the broadcast program can be prefetched. In another example, if the receiver is in a standby state, the receiver may wake up from the standby state at the predefined times in order to prefetch the broadcast program.

In some embodiments, the broadcast program may be prefetched in the background and be transparent to the consumer. If the broadcast program that is to be prefetched uses the same frequency as a current broadcast program that is being rendered and viewed by the consumer, then the broadcast program may be fetched in the background while the current broadcast program is being rendered. In other words, if the currently rendered broadcast program and the broadcast program to be prefetched belong to the same transport stream, then a first tuner which is locked to the frequency of the currently rendered broadcast program may be used to prefetch the broadcast program in the background while the current broadcast program is being rendered. However, if the broadcast program to be prefetched belongs to a different transport stream than the transport stream of the currently rendered broadcast program, then a second tuner in the receiver may be used to lock to the frequency of the transport stream associated with the broadcast program to be prefetched. Thereafter, the broadcast program to be prefetched may be fetched in the background by the second tuner. If two broadcast programs are to be prefetched wherein one broadcast program belongs to a first transport stream and another belongs to a second transport stream, then two tuners tuned to the frequencies of the first transport stream and the second transport stream may be used to prefetch the two broadcast programs simultaneously. Thus, broadcast programs transmitted across multiple transport streams may be prefetched simultaneously based on the number of tuners available.

In some embodiments, the prefetched broadcast program may be encrypted such that the prefetched broadcast program is not accessible or usable prior to the interruption in the reception of the broadcast program. To this end, a Special Scrambling Key (SSK) may be associated with the prefetched broadcast program. The SSK may be transmitted to the receiver at the start time of the actual broadcast program and may be used to decrypt the prefetched broadcast program at the time of interruption. However, if the receiver is unable to receive the SSK due to unavailability of signal, then the receiver may fetch the SSK from the broadcaster using a return channel between the receiver and the broadcaster.

If no interruption of the broadcast signal occurs while receiving the broadcast program from the broadcast medium, the prefetched broadcast program may be automatically deleted from the local storage device when the actual transmission of the broadcast program on the broadcast medium ends. In other words, in some embodiments, the local storage device may be configured to store and allow access to the prefetched broadcast program only for the scheduled duration of the broadcast program. In some embodiments, the prefetched broadcast program may be deleted in increments as and when the broadcast program is received from the broadcast medium prior to the interruption of the broadcast signal. To accomplish this, the receiver may regularly transmit positions of marker packets received in the transport stream corresponding to the broadcast program to the local storage device. The local storage device may then delete a portion of the prefetched broadcast program prior to the position indicated by a received marker packet.

In addition to or alternate to the local storage device, the one or more standby sources may include an internet based broadcast server. In this case, the internet based broadcast server may automatically provide an interrupted broadcast program by streaming the broadcast program when an interruption occurs. The streaming of the interrupted broadcast program may be transparent to the user and not require any user input. For example, if a Live broadcast event is interrupted due to a loss of broadcast signal, then the broadcast event may be automatically provided from the internet based broadcast server. The interrupted broadcast program may be streamed to the receiver over the return channel of the receiver.

When an interruption in the reception of the one or more received broadcast programs that are monitored (hereinafter referred as “monitored broadcast programs”) occurs, the monitored broadcast programs may be provided from the one or more standby sources from a point of interruption of the monitored broadcast programs. In some embodiments, to provide the monitored broadcast programs from the point of interruption, a plurality of marker packets may be inserted in each of the one or more transport streams at predefined intervals. The predefined intervals at which the marker packets are inserted may be specified by the broadcaster or the consumer of the received broadcast programs. Thus, each received broadcast program associated with the one or more transport streams may be divided into a plurality of segments separated by the plurality of marker packets. For example, a sixty minute broadcast program may be divided into sixty equal segments of data. A first segment of data may correspond to the broadcast program data of the first minute. Similarly, a second segment of data may correspond to the broadcast program data of the second minute and so on. Each segment may be identified by inserting a start marker packet before the first transport stream packet and an end marker packet after the end of the last transport stream packet of the respective segment. Marker packets may be identified by a unique Packet Identifier (PID). Each marker packet may also contain information on the segment number in a payload. Marker packets may further contain service information to uniquely identify the service/s being tracked by the receiver. In other words, the receiver may be capable of distinguishing and tracking multiple broadcast programs irrespective of whether the broadcast programs belong to different services or channels of a single transport stream or multiple transport streams.

On interruption of a monitored broadcast program, a position of a last marker packet passed in a transport stream corresponding to the monitored broadcast program immediately prior to the interruption may be determined. Similarly, the last marker packet passed in each transport stream corresponding to each monitored broadcast program immediately prior to the interruption in the reception of the monitored broadcast programs may be determined. For example, a first broadcast program transmitted on a first transport stream and a second broadcast program transmitted on a second broadcast stream may have different positions of last marker packets associated with them even though the first transport stream and the second transport stream may have the same point of interruption. Thus, each monitored broadcast program may be associated with different last marker packet positions when an interruption occurs. If multiple broadcast programs having an overlapping timeslot are chosen to be monitored and provided from the one or more standby sources, unique identification and tracking of marker packets by means of service identification inside their payload enables the receiver to keep track of the last marker packet of each of the multiple broadcast programs.

After the last marker packets associated with each of the monitored broadcast programs is determined, the positions of the last marker packets may be transmitted to the one or more standby sources. The positions of the last marker of each monitored broadcast program may be transmitted to one or more of the local storage device and the internet based broadcast server, based on whether a monitored broadcast program is a pre-recorded broadcast program or a Live broadcast program. If a monitored broadcast program is a pre-recorded broadcast program and has been prefetched into the local storage device, then the local storage device may compare the received last marker packet with marker packets associated with the prefetched broadcast program to determine a resume point. Accordingly, the prefetched broadcast program may be resumed from the local storage device from the position of the last marker packet passed before the interruption in reception of the broadcast program. In some embodiments, the pre-recorded broadcast program may also be streamed from the internet based broadcast server from the position of the last marker packet. For Live broadcast programs, the position of the last marker packet received prior to interruption of the Live broadcast program may be transmitted to the internet based broadcast server. Thereafter, the internet based broadcast server may stream the Live broadcast program from the position of the last marker packet.

The monitored programs, once provided by the one or more standby sources, may be displayed on a display device such as a television of the consumer. In some embodiments, one broadcast program of the monitored broadcast programs provided by the one or more standby sources may be displayed at an instance of time. The consumer may switch between the one or more broadcast programs provided by the one or more standby sources at different instances of time. In some embodiments, if the receiver supports a picture-in-picture functionality wherein multiple tuners are used to tune into different frequencies, then more than one broadcast program provided by the one or more standby sources may be displayed at the same time.

In some embodiments, the reception of the monitored broadcast programs may be resumed from the broadcast medium after rectification of the interruption in the reception of the monitored broadcast programs. In other words, the reception of the monitored broadcast programs may resume from the one or more of the satellite medium, the cable medium, and the terrestrial medium when the one or more of the satellite medium, the cable medium, and the terrestrial medium become available after the interruption. In some embodiments, reception of the monitored broadcast programs from the broadcast medium may be initiated automatically. That is, the monitored broadcast programs may be received from the broadcast medium as soon as the broadcast signal is available. In some embodiments, switching the reception of the monitored broadcast programs from the one or more standby sources to the broadcast medium may occur automatically without requiring any input from the consumer. Alternatively, the consumer may be provided a pop-up window or any other user interface element indicating that the broadcast signal is available and prompting the consumer to select if the broadcast programs are to be continued to be provided from the one or more standby sources or if the consumer would like to switch over to the broadcast medium.

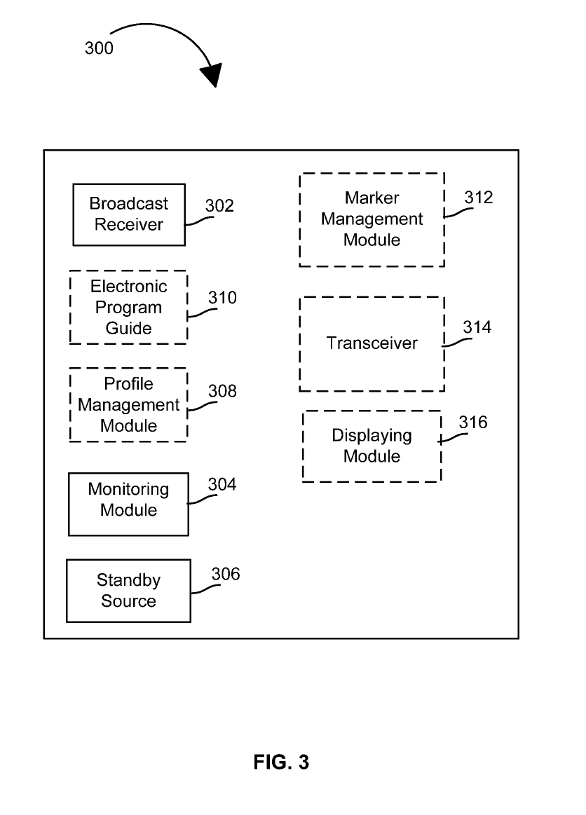

An uninterrupted broadcast content provisioning system 300 will now be explained in conjunction with a block diagram as illustrated in FIG. 3. System 300 may include a broadcast receiver 302, a monitoring module 304, and one or more standby sources such as a standby source 306. Broadcast receiver 302 may be configured to receive one or more transport streams corresponding to one or more broadcast programs through a broadcast medium. The one or more transport streams may be transmitted to broadcast receiver 302 by a broadcaster using one or more of a satellite medium, a cable medium, and a terrestrial medium. Broadcast receiver 302 may include one or more of one or more antennas and one or more tuners to receive the one or more broadcast programs (hereinafter referred as “received broadcast programs”). In some embodiments, broadcast receiver 302 may be associated with a television, wherein broadcast receiver 302 is configured to receive broadcast signals corresponding to broadcast television programs. Broadcast receiver 302 may be configured to receive the broadcast signals transmitted over the air or over cables. In some embodiments, broadcast receiver 302 may be associated with a set top box.

As broadcast receiver 302 receives the one or more transport streams, monitoring module 304 may monitor one or more of the received broadcast programs associated with the one or more transport streams. Monitoring module 304 may monitor the one or more received broadcast programs to detect if an interruption in reception of the one or more received broadcast programs occurs. In some embodiments, monitoring module 304 may include one or more hardware processors to monitor the one or more received broadcast programs. Monitoring module 304 may monitor all the broadcast programs received from the broadcast medium or may selectively monitor one or more of the received broadcast programs. The one or more received broadcast programs to be monitored may be chosen automatically based on a profile of a consumer and/or manually chosen by the consumer as explained in conjunction with FIG. 2. A profile management module 308 may manage the profile of the consumer. In an exemplary embodiment, profile management module 308 may receive preferences associated with the consumer during setup. These preferences may include, but is not limited to, preferred genres of broadcast programs and preferred broadcast programs, as well as prediction data referred to earlier in this disclosure. In some embodiments, profile management module 308 may dynamically track viewing patterns of the consumer and update the profile of the consumer periodically.

System 300 may further include an Electronic Program Guide (EPG) 310 configured to allow the consumer to dynamically choose the one or more received broadcast programs to be monitored. EPG 310 may be an application that lists current and future scheduled broadcast programs. EPG 310 may be configured to receive input by the consumer corresponding to selection of one or more broadcast programs to be monitored.

In the course of monitoring the one or more received broadcast programs, if the monitoring module 304 detects an interruption in the reception of the monitored broadcast programs, monitoring module 304 may cause the one or more standby sources such as standby source 306 to automatically provide the monitored broadcast programs. In some embodiments, standby source 306 may include a local storage device associated with broadcast receiver 302. The local storage device may include, but not be limited to, a hard disk included within broadcast receiver 302 and an external storage device such as an USB drive or an external hard disk device that may be removably connected to broadcast receiver 302 as and when required.

The local storage device may provide one or more of the monitored broadcast programs when an interruption occurs by prefetching the one or more of the monitored broadcast programs to the local storage device before the start of transmission of the one or more monitored broadcast programs on the broadcast medium. Prefetching the one or more monitored broadcast programs is elaborated in detail in conjunction with the description of FIG. 2. As explained in conjunction with FIG. 2, a broadcaster may transmit the times at which the one or more monitored broadcast programs will be available to be prefetched. These timings may be recorded in EPG 310 or another EPG may be created that shows a listing of the monitored broadcast programs and the times at which one or more of these monitored broadcast programs are to be prefetched. Broadcast receiver 302 may use these timings to prepare to prefetch the broadcast program into the local storage device as explained in conjunction with FIG. 2.

In some embodiments, a prefetched broadcast program may be encrypted such that the prefetched broadcast program is not accessible or usable prior to the interruption in the reception of the broadcast program. To this end, a Special Scrambling Key (SSK) may be associated with the prefetched broadcast program. The SSK may be transmitted to broadcast receiver 302 at the start time of the actual broadcast program and may be used to decrypt the prefetched broadcast program at the time of interruption. However, if broadcast receiver 302 is unable to receive the SSK due to unavailability of signal, then broadcast receiver may fetch the SSK from the broadcaster using a return channel between broadcast receiver 302 and the broadcaster.

If no interruption of the broadcast signal occurs while receiving the broadcast program from the broadcast medium, the prefetched broadcast program may be automatically deleted from the local storage device when the actual transmission of the broadcast program on the broadcast medium ends. In other words, in some embodiments, the local storage device may be configured to store and allow access to the prefetched broadcast program only for the scheduled duration of the broadcast program. In some embodiments, the prefetched broadcast program may be deleted in increments as and when the broadcast program is received from the broadcast medium prior to the interruption of the broadcast signal. To accomplish this, broadcast receiver 302 may regularly transmit positions of marker packets received in the transport stream corresponding to a broadcast program to the local storage device. The local storage device may then delete one or more portions of the corresponding prefetched broadcast program prior to the position indicated by a received marker packet.

In some embodiments, standby source 306 may include an internet based broadcast server. Monitoring module 304 in this case may be configured to automatically cause the internet based broadcast server to stream the broadcast program when a signal loss occurs. The internet based broadcast server may stream the broadcast program to broadcast receiver 302 over a return channel of the receiver.

When an interruption in the reception of the monitored broadcast programs occurs, the monitored broadcast programs are provided from standby source 306 from a point of interruption of the monitored broadcast programs. In some embodiments, to provide the monitored broadcast programs from the point of interruption, a plurality of marker packets may be inserted by the broadcaster into the one or more transport streams at predefined intervals as explained in conjunction with FIG. 2. On interruption of the monitored broadcast programs, a marker management module 312 may determine a position of a last marker packet passed in each transport stream corresponding to each of the monitored broadcast programs immediately prior to the interruption. Thereafter, the position of the last marker packet associated with each broadcast program may be transmitted to standby source 306 using a transceiver 314. If standby source 306 is a local storage device and a monitored broadcast program has been prefetched into the local storage device, then the local storage device may compare the last marker passed in the transport stream of the monitored broadcast program with marker packets associated with the prefetched broadcast program to determine a resume point. Accordingly, the monitored broadcast program may be provided from the local storage device from the position of the last marker packet passed before the interruption of the broadcast program. Similarly, when standby source 306 is an internet based broadcast server, the position of the last marker packet may be transmitted to the internet based broadcast server. Thereafter, the monitored broadcast program is streamed from the position of the last marker packet. The steps of inserting marker packets in each of the transport streams, determining positions of last marker packets passed in each monitored broadcast program, transmitting the last marker packets to the one or more standby sources and providing the monitored broadcast programs from one or more standby sources is described in detail in conjunction with FIG. 2.

System 300 may further include a displaying module 316 configured to display one or more of the monitored broadcast programs provided by standby source 306. Displaying module 316 may receive the one or more broadcast programs provided by standby source 306 and perform one or more processing steps to render one or more of the one or more broadcast programs provided by standby source 306 on a display device at an instance of time. The consumer may switch between a first broadcast program and a second broadcast program provided by standby source 316 at different instances of time. In some embodiments, if broadcast receiver 302 supports a picture-in-picture functionality wherein multiple tuners are used to tune into different frequencies, then more than one broadcast program provided by standby source 306 may be displayed at the same time.

In some embodiments of the invention, broadcast receiver 302 may be configured to resume the reception of the monitored broadcast programs from the broadcast medium after rectification of the interruption. Broadcast receiver 302 may receive the broadcast program from one or more of the satellite medium, the cable medium, and the terrestrial medium when the broadcast signal becomes available on the one or more of the satellite medium, the cable medium, and the terrestrial medium. In some embodiments, reception of the monitored broadcast programs from the broadcast medium by broadcast receiver 302 may be automatically initiated. The monitored broadcast programs may be automatically received from the broadcast medium as soon as the broadcast signal is available. Switching the reception of the monitored broadcast programs from standby source 306 to the broadcast medium may occur automatically without requiring any input from the consumer. Alternatively, broadcast receiver may be configured to provide the consumer a pop-up window or any other user interface element indicating that the broadcast signal is available and prompting the consumer to select if the broadcast program is to be continued to be provided from standby source 306 or if the consumer would like to switch over to the broadcast medium.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

1. An uninterrupted broadcast content provisioning method, comprising:
receiving at least one transport stream corresponding to at least one broadcast program, the at least one transport stream transmitted using at least one of: a satellite medium, a cable medium, and a terrestrial medium;
monitoring, using at least one hardware processor, at least one of the at least one broadcast program to detect, during transmission of the at least one transport stream, an interruption in reception of the at least one of the at least one broadcast program; and
receiving the at least one of the at least one broadcast program automatically from at least one standby source after detecting the interruption in the reception of the at least one of the at least one broadcast program during transmission of the at least one transport stream;
wherein the at least one of the at least one broadcast program is received from the at least one standby source from a point of interruption of the at least one of the at least one broadcast program.

2. The method of claim 1, wherein a broadcast program of the at least one broadcast program comprises a television broadcast program.

3. The method of claim 1, wherein the at least one of the at least one broadcast program to be monitored is at least one of automatically chosen based on a profile of a consumer and manually chosen by the consumer.

4. The method of claim 1, wherein a standby source of the at least one standby source comprises a local storage device, wherein at least one of the at least one broadcast program is prefetched to the local storage device.

5. The method of claim 1, wherein a standby source of the at least one standby source comprises an internet based broadcast server, wherein the internet based broadcast server streams at least one of the at least one broadcast program.

6. The method of claim 1, wherein a plurality of marker packets are inserted in each of the at least one transport stream at predefined intervals.

7. The method of claim 6, wherein the predefined intervals are specified by at least one of a broadcaster associated with the at least one broadcast program, and a consumer of the at least one broadcast program.

8. The method of claim 6, wherein receiving the at least one of the at least one broadcast program automatically from the standby source comprises:
determining a position of a last marker packet passed in a transport stream corresponding to the at least one of the at least one broadcast program immediately prior to the interruption in the reception of the at least one of the at least one broadcast program;
transmitting the position of the last marker packet associated with the at least one of the at least one broadcast program to the at least one standby source; and
receiving the at least one of the at least one broadcast program from the at least one standby source, from the position of the last marker packet associated with the at least one of the at least one broadcast program.

9. The method of claim 1, further comprising displaying at least one of the at least one broadcast program provided from the at least one standby source at an instance of time.

10. The method of claim 1, further comprising resuming reception of the at least one of the at least one broadcast program from the at least one of: the satellite medium, the cable medium and the terrestrial medium, after rectification of the interruption in the reception of the at least one of the at least one broadcast program.

11. The method of claim 10, wherein resuming reception of the at least one of the at least one broadcast program is one of: automatically initiated and consumer initiated.

12. An uninterrupted broadcast content provisioning system, comprising:
one or more hardware processors; and
one or more memory units storing instructions executable by the one or more processors to:
receive at least one transport stream corresponding to at least one broadcast program, the at least one transport stream transmitted using at least one of: a satellite medium, a cable medium, and a terrestrial medium;
monitor at least one of the at least one broadcast program to detect, during transmission of the at least one transport stream, an interruption in reception of the at least one of the at least one broadcast program; and
receive the at least one of the at least one broadcast program automatically from at least one standby source after detection of the interruption in the reception of the at least one of the at least one broadcast program during transmission of the at least one transport stream;
wherein the at least one of the at least one broadcast program is received from the at least one standby source from a point of interruption of the at least one of the at least one broadcast program.

13. The system of claim 12, the one or more memory units further storing instructions to:
provide an Electronic Program Guide configured to allow a consumer to choose the at least one of the at least one broadcast program to be monitored.

14. The system of claim 12, the one or more memory units further storing instructions to:
manage a profile of a consumer, wherein the profile of the consumer is used to automatically select the at least one of the at least one broadcast program.

15. The system of claim 12, wherein a standby source of the at least one standby source comprises a local storage device, wherein at least one of the at least one broadcast program is prefetched to the local storage device.

16. The system of claim 12, wherein a standby source of the at least one standby source comprises an internet based broadcast server, wherein the internet based broadcast server streams at least one of the at least one broadcast program.

17. The system of claim 12, wherein a plurality of marker packets are inserted in each of the at least one transport stream at predefined intervals.

18. The system of claim 17, the one or more memory units further storing instructions to:
determine a position of a last marker packet passed in a transport stream corresponding to at least one of the at least one broadcast program immediately prior to the interruption in the reception of the at least one of the at least one broadcast program.

19. The system of claim 18, further comprising a transceiver for transmitting the position of the last marker packet associated with each of the at least one of the at least one broadcast program to the at least one standby source.

20. The system of claim 19, wherein the at least one standby source is configured to provide the at least one of the at least one broadcast program from the position of the last marker packet associated with each of the at least one of the at least one broadcast program.

21. The system of claim 12, further comprising a display system configured to display at least one of the at least one broadcast program provided from the at least one standby source at an instance of time.

22. The system of claim 12, wherein the one or more processors are configured to resume reception of the at least one of the at least one broadcast program from at least one of: the satellite medium, the cable medium, and the terrestrial medium, after rectification of the interruption in the reception of the at least one of the at least one broadcast program.

23. The system of claim 22, wherein resuming reception of the at least one of the at least one broadcast program is one of: automatically initiated, and consumer initiated.
